(19) United States
(12) Patent Application Publication
(10) Pub. No.: US 2002/0162596 A1
(43) Pub. Date: Nov. 7, 2002

(54) Bore-lining tubing

(76) Inventor: Neil Andrew Abercrombie Simpson, Aberdeen (GB)

Correspondence Address: WILLIAM B. PATTERSON, MOSER, PATTERSON & SHERIDAN, L.L.P., 3040 Post Oax Blvd., Suite 1500, Houston, TX, 77056, US

(21) Appl. No.: 10/115,434

(22) Filed: Apr. 3, 2002

(30) Foreign Application Priority Data
Apr. 4, 2001 (GB) 0108384.9

(51) Int. Cl. F16L 55/16

(52) U.S. Cl. 138/98; 138/125; 138/104; 138/34

(57) ABSTRACT

A method of lining a bore section, the method comprises providing a first tubing section (12) and an expandable thin-walled second tubing section (14). The first tubing section (12) is run into a section of a bore (10). The second tubing section (14) is then run into the bore section (10), within the first tubing section (12), and expanded to a larger diameter, such that the bore section is lined by at least two tubing sections (12, 14).

### FIELD OF THE INVENTION

This invention relates to bore-lining tubing, and to bores lined with such tubing. The invention also relates to methods of expanding bore-lining tubing downhole.

### BACKGROUND OF THE INVENTION

The oil and gas exploration and production industry is making increasing use of expandable tubing for use as bore-lining casing and liner, as well as in straddles and in sand screens. The primary advantage of such tubing is that it can be run through a restriction, such as an existing cased section of bore, and then expanded to a diameter corresponding to the existing casing section. It is anticipated that this will permit the creation of “monobore” wells; that is wells having a bore of substantially constant diameter, in contrast to current wells in which the well diameter tends to decrease from surface in a stepwise fashion.

It is among the objectives of embodiments of the present invention to provide a method of lining a bore utilising a plurality of coaxial expandable tubes.

### SUMMARY OF THE INVENTION

According to a first aspect of the present invention, there is provided a method of lining a bore section, the method comprising:

providing an expandable first tubing section and an expandable second tubing section;

running the first tubing section into a section of a bore;

expanding the first tubing section to a larger diameter;

running the second tubing section into said bore section, within the expanded first tubing section; and

expanding the second tubing section to a larger diameter such that said bore section is lined by at least two expanded tubing sections.

The invention also relates to a well bore created using this method, and to the apparatus utilised to line bores in accordance with the method.

The method of the invention offers many advantages over conventional expandable tubing bore-lining methods, whereby a bore section is lined with only a single expanded tubing section. The only parts of such a conventional bore where two expanded tubing sections are present are where adjacent tubing sections overlap, where it is generally necessary for the overlapping tubing sections to be expanded simultaneously, to prevent a step-change in internal bore diameter at the overlap.

The present invention allows relatively thin-walled tubing to be utilised to line a bore. The combination of two or more relatively thin-walled tubing sections tends to create a composite bore-lining of equivalent or greater strength than a single section of relatively thick-walled tubing. Of course it is also possible to build up an expanded composite wall, incorporating two, three or more tubing sections, of considerable thickness. It has also been found that in such a composite expanded tubing liner the resistance of the expanded inner tubing section to external crushing forces, such as would be produced by an elevated external pressure, is surprisingly high. The invention also permits a bore lining to be composed of tubing sections of different materials or different structures, for example an outer tubing section of relatively inexpensive material may be lined with a relatively thin inner tubing section of more expensive corrosion-resistant material, rather than providing a single relatively thick-walled and thus expensive tubing section of the corrosion-resistant material. In other embodiments a tubing section of relatively inexpensive material may be sandwiched between two tubing sections of more expensive corrosion resistant materials. Alternatively, or in addition, an outer expanded slotted tubing section may be lined with an inner solid walled inner tubing section, to provide a fluid-tight composite expanded liner which will withstand elevated external fluid pressure forces. Of course the relative positions of the tubing sections could be reversed, with the solid walled tubing being located externally of the slotted tubing. In other embodiments one or more of the tubing sections may be of non-metallic material, typically a polymeric material. For example, polyurethane tubing, as sold under the Polybore trade mark, may be run into a bore section, the tubing expanding into contact with the surrounding casing in response to the elevated temperatures experienced downhole. It is known to use such tubing to line and seal existing casing which has been subject to erosion or corrosion, however the expanded polyurethane tubing only has limited strength to resist external pressure or crush forces. However, utilising the present invention, a length of expandable metallic solid-walled tubing may be run in and then expanded into contact with the previously expanded polyurethane tubing, and so provide the polyurethane tubing with internal support. In still further embodiment, a section of open bore may be initially lined with thin-walled tubing, to prevent lost circulation. The bore may then be lined with a corrugated tubing, to provide enhanced crush resistance, that is resistance to external pressure forces. The corrugated tubing may be corrugated axially, helically or circumferentially. Subsequently, an inner lining of thin-walled tubing may be installed, to provide a smooth internal bore wall. During the installation of the inner tubing, the expansion of the inner tubing may be such that the corrugated tubing is flattened, or at least partially flattened. However, it may be desired to retain voids within the bore wall to provide, for example, enhanced insulation or to permit fluid circulation axially through the bore-lining, between the inner and outer tubing.

As noted above, one of the primary advantages of embodiments of the present invention is that composites or laminates of relatively thin tubing, which is therefore relatively light-weight and flexible, may be utilised for lining bores. Conventional casing and liner typically ranges in wall thickness from 6 mm to 20 mm, depending on tubing diameter, material and application. However, the present invention allows use of thinner tubing, that is tubing having a wall thickness of less than 6 mm, and preferably around 3 mm to 4 mm.

Conventional expanded tubing has tended to be formed of extruded tubing, which is relatively expensive and time consuming to produce. However, with the benefit of the present invention tubing sections of rolled and welded metal sheet may be utilised. The potential or perceived weak point of the tubing, at the welded joint, is protected and supported by the tubing sections located internally or externally of the welded tubing. Where two or more welded tubing sections are utilised, the weld locations of the different tubing sections may be circumferentially spaced apart.

Of course, relatively thin tubing section generally requires application of lower forces to expand the tubing, facilitating the expansion operation, and providing greater freedom in the range of bores in which expanded tubing may be provided, and the apparatus and methods used to run in and expand the tubing. Each tubing section may also be of relatively light weight, facilitating the handling and running of the tubing, particularly when dealing with larger tubing diameters. For example, running conventional larger diameter casing involves many difficulties, due primarily to the weight of the casing and the large frictional forces that may be encountered. By replacing such casing with a composite expanded casing many of these difficulties may be avoided: the individual tubing sections are lighter and initially of a smaller diameter, and are therefore easier to run into a bore, and may be rotated to facilitate overcoming obstacles in the bore and to facilitate cementing. The reduction in weight of the tubing also facilitates the running of longer tubing sections. In one embodiment, a bore may be initially lined with a number of separately run tubing sections, and then a final tubing section run into the bore, which tubing section may carry conduits or conductors as described below, and expanded to line substantially the entire length of the bore.

The invention also facilitates provision of bore-linings having particular desirable properties or features. For example, by locating a heat-insulating material or arrangement between expanded first and second tubing sections it may be possible to maintain fluid flowing through the tubing at a relatively high temperatures, which may be useful in avoiding separation or precipitation of different fractions in certain formation fluids. Tubing sections may be electrically insulated or electrically coupled to permit signals or power to be transmitted via the bore-lining. Alternatively, or in addition, separate conductors or conduits may be located or sandwiched between first and second expanded tubing sections, or may be incorporated into a tubing section. The conductors or conduits may be encapsulated in a polymer or elastomer sheath on the inner tubing section. Alternatively, or in addition, the conductors or conduits may be incorporated or encapsulated in a separate expandable polymeric or elastomer tube. Such conduits or conductors may include electrical wiring, fibre optic cables, or fluid conduits. In the interests of brevity, the term “conduit” may be used herein as indicative of any of such conduits or conductors. In other embodiments, abutting surfaces of adjacent tubing sections may define channels such that the composite tubing defines fluid conduits between the tubing sections.

Where electrical conductors are provided, these may be arranged to define, for example, coils or windings which may be utilised as stators for electric motors or for the inductive transfer of power or information. Conductors or magnets could also be provided to form a linear motor in the tubing.

A difficulty which is present in the proposed monobore wells created using conventional expandable tubing is mentioned above, that is the requirement to expand the overlapping ends of adjacent tubing sections simultaneously. A further difficulty arises when the previously expanded tubing has been cemented, and the cement has set, as it is difficult if not impossible to expand cemented tubing. Using the present invention, these difficulties may be avoided as it is no longer necessary to overlap the ends of adjacent tubing sections to create a seal: outer tubing sections may be located end-to-end in the bore, without overlap, and inner tubing sections then run in and expanded with the ends of the inner tubing sections spaced from the ends of the outer sections. The contact between the inner and outer tubing sections may be itself sufficient to provide the necessary sealing between the bore wall and the interior of the composite tubing, and indeed seal arrangements may be provided between the inner and outer tubing sections to provide a barrier to fluid flow between the tubing sections. Alternatively, or in addition, the outer tubing sections may be provided with end portions which may be overlapped, which end portions may be relatively thin-walled or of relatively flexible material, or which end portions may be removed before location of the inner tubing sections in the bore, or which end portions may be accommodated by deformation or profiling of the inner tubing sections.

The ability to utilise relatively thin-walled tubing sections provides greater flexibility in the form of the tubing sections, in that where a conventional bore-lining operation may have required use of relatively heavy jointed tubing, the invention facilitates use of lighter reelable tubing, and also the use of “C-shaped” or flattened tubing which is run into the bore in a folded or flattened form and then subsequently unfolded, and possibly then further expanded.

### BRIEF DESCRIPTION OF THE DRAWINGS

These and other aspects of the present invention will now be described, by way of example, with reference to the accompanying drawings, in which:

FIG. 1 is a schematic sectional view of a composite tubing-lined well bore in accordance with an embodiment of the present invention;

FIG. 2 is a sectional view of a part of the well bore of FIG. 1; and

FIG. 3 is a schematic illustration of a feature of the bore-lining tubing of FIG. 1.

### DETAILED DESCRIPTION OF THE DRAWINGS

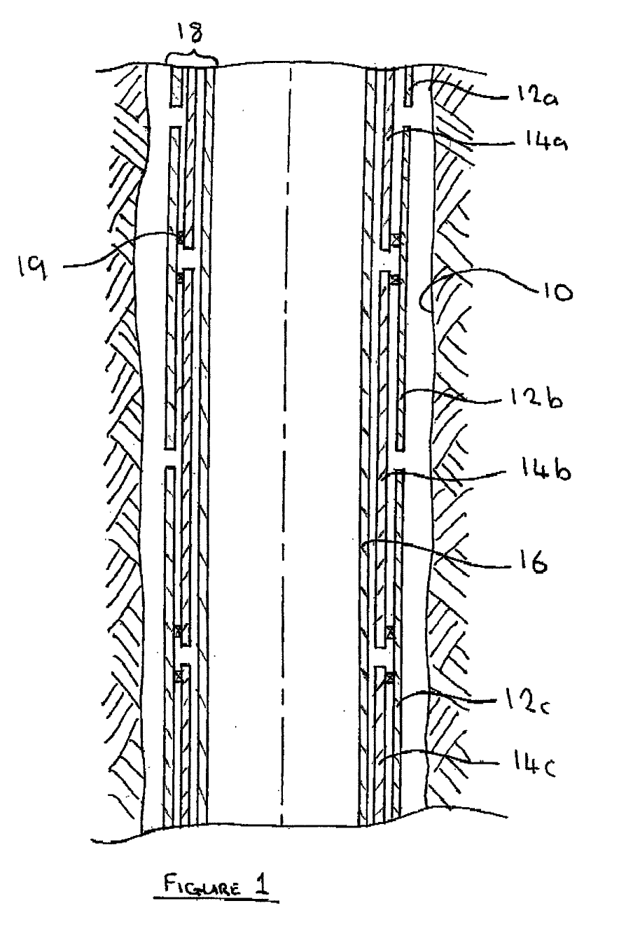

Reference is first made to FIG. 1 of the drawings, which illustrates a drilled bore 10 which has been lined with expandable metal tubing, in accordance with a method of an embodiment of the present invention. In particular, the bore 10 has been lined with a series of outer tubing sections 12a, 12b, 12c, intermediate tubing sections 14a, 14b, 14c, and an inner tubing section 16. Together, the various tubing sections 12, 14, 16 form a composite bore-lining casing 18.

The casing 18 is created as described below. Following the drilling of the bore 10, a first outer tubing section 12a is introduced into the bore 10, in an unexpanded, smaller diameter configuration. The tubing section 12a is run into the desired location in the bore 10 and then expanded to a larger diameter, as illustrated in FIG. 1. The tubing section 12a may also be cemented in the bore 10. A second outer tubing section 12b is then run into the bore 10, in unexpanded condition, and located below the first outer tubing section 12a. The second tubing section 12b is then expanded to a diameter corresponding to the diameter of the first tubing section 12a. As will be noted from FIG. 1, the ends of the tubing sections 12a, 12b do not overlap; rather, the sections 12a, 12b are positioned in end-to-end relationship. Depending on bore conditions a further tubing section 12c may be run in and expanded, below the tubing section 12b.

Once the outer tubing sections 12a, 12b, 12c are in place, a first intermediate tubing section 14 is run into the bore, in unexpanded condition, and then expanded to engage the inner wall of the tubing section 12a (to allow the different tubing sections to be more readily identified, the figures shown the tubing sections spaced apart). Seals 19 are provided towards the end of the tubing section 14a, such that when the tubing section 14a is expanded into contact with the outer tubing section 12a the seals 19 create a barrier to fluid movement between the tubing sections 12a, 14a. This process is then repeated with the further intermediate tubing sections 14b, 14c, and it will be noted that the seals 19 ensure that there is no fluid path between the bore wall 10 and the interior of the intermediate tubing sections 14a, 14b, 14c.

As the bore 10 is drilled deeper, further outer and intermediate tubing sections 12, 14 may be run into the bore 10 and expanded, to line and isolate the bore wall. Once the drilling of the bore 10 has been completed, and all of the appropriate tubing sections 12, 14 run in and expanded, the continuous inner tubing section 16 is run into the bore in unexpanded condition, and then expanded into contact with the inner face of the intermediate tubing sections 14.

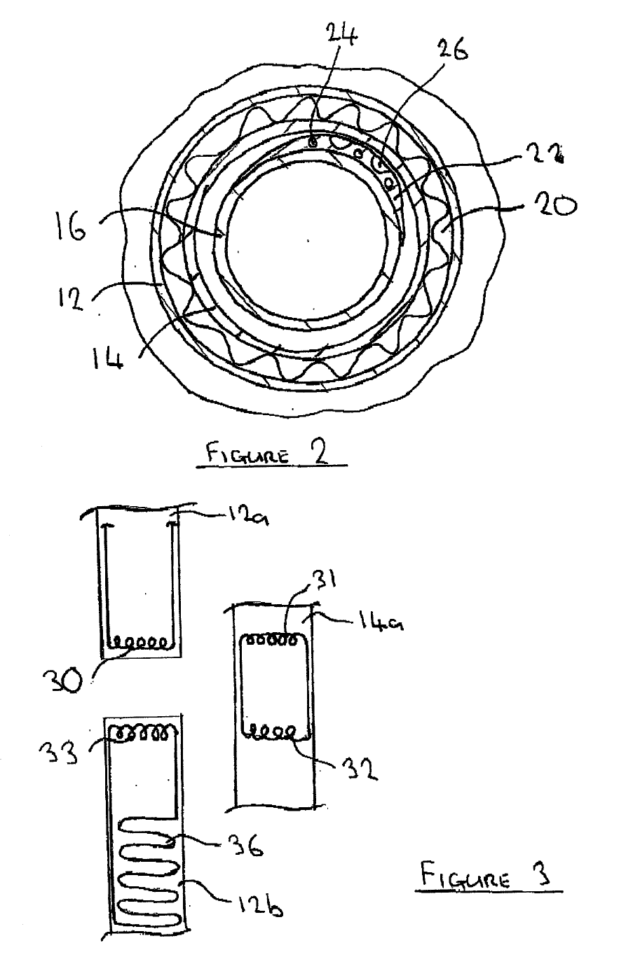

Reference is now also made to FIG. 2 of the drawings, which shows a cross-section of the lined bore. At the location of this section, the intermediate tubing section 14 has been provided with a sleeve 20 of an insulating material, which is sandwiched between the tubing sections 12, 14 on expansion of the intermediate tubing section 14. This assists in maintaining the temperature of formation fluids being removed from the bore.

In addition, it will be noted that the inner tubing section 16 carries a crescent-shaped segment of elastomeric material 22 defining, in this example, three conduits 24 and two channels 26. The conduits 24 may be utilised to transfer fluids, or may contain signal-carrying elements, such as wiring or optical fibres. The channels 26 may be used to carry fluids, as when the inner tubing 16 is expanded the segment 22 will engage the intermediate tubing section 14, and thus close the channel 26.

In this example, the inner tubing section 16 is formed of a reelable tubing section, such that the conduits 24 and channels 26 may be continuous over the length of the tubing section 16. Where jointed tubing is used, it may be more convenient to provide the individual tubing joints with a profile such as profile 22 illustrated in FIG. 2, or alternatively a sheath, provided with channels or slots into which cables, conductors or other signal carriers may be located as the tubing is being run into the bore, rather than attempting to make the conduits integral with the tubing.

An alternative arrangement for providing communication between jointed tubing sections is illustrated schematically in FIG. 3 of the drawings. In this illustration, overlapping tubing sections 12a, 14a, 12b incorporate electrical conductors which are formed into coils 30, 31, 32, 33. The coils are located such that, where the expanded tubing sections overlap, the coils 30, 31 and 32, 33 are adjacent one another, such that there may be inductive transfer of energy between the coils, allowing transfer of energy in the absence of any direct physical connection.

The conductor in the tubing section 12b is illustrated as being formed into a further coil or winding 36, which is arranged to form the stator of an electric motor, to be used to drive an electric submersible pump (ESP). Thus, it is possible to run in a pump body containing only the pump rotor, for use in combination with the stator 36 which has already been located in the bore lining. Of course in such an arrangement it would be necessary for the inner tubing 16 to be formed of nonmagnetic material.

In other embodiments, the coil 36 could be utilised for inductively charging downhole apparatus, such as a downhole autonomous tractor to allow extended operation downhole, and also permitting inductive transfer of information to surface.

It will be apparent to those of skill in the art that the above-described embodiments are merely exemplary of the present invention, and that many further modifications and improvements may be made to the illustrated embodiment without departing from the scope of the present invention. For example, in the illustrated embodiment the various tubing sections all have solid walls, and in other embodiments one or more of the tubing sections could be slotted. Further, in other embodiments the composite casing may comprise only two expanded tubing sections, or indeed four or more tubing sections. Also, a number of the features mentioned above may be utilised in bores where a single tubing section is expanded within an existing tubing section, which may or may not have previously been expanded. The invention also applies to tubing which will expand without external intervention, for example certain materials will expand on exposure to the elevated temperatures experienced in deep bores. Such materials, such as the reelable tubing sold under the Polybore trade mark, may have limited physical strength, but can provide useful fluid barriers, and may be sandwiched between structural tubing.

1. A method of lining a bore section, the method comprising:
providing a first tubing section and an expandable thin-walled second tubing section;
running the first tubing section into a section of a bore;
running the expandable thin-walled second tubing section into said bore section, within the first tubing section; and
expanding the thin-walled second tubing section to a larger diameter, such that said bore section is lined by at least two tubing sections.

2. The method of claim 1, wherein said first tubing section is an expandable tubing section.

3. The method of claim 2, wherein said first tubing section is an expandable thin-walled tubing section.

4. The method of claim 3, further comprising the step of expanding the first tubing section to a larger diameter before running said second tubing section into the bore.

5. The method of claim 1, wherein at least one further tubing section is run into the bore, within the first and second tubing sections, and expanded to a larger diameter.

6. The method of claim 1, wherein at least one further thin-walled tubing section is run into the bore, within the first and second tubing sections, and expanded to a larger diameter.

7. The method of claim 1, further comprising running at least one of the tubing sections into said bore section together with at least one conduit.

8. The method of claim 7, wherein the at least one conduit is located such that said bore section is lined by at least two tubing sections with at least one conduit therebetween.

9. The method of claim 7, wherein said at least one conduit is carried externally by said at least one tubing section.

10. The method of claim 7, wherein the at least one conduit is encapsulated in a polymeric element on the second tubing section.

11. The method of claim 7, wherein said at least one conduit includes at least one of electrical wiring, fibre optic cables, and pressure conduits.

12. The method of claim 11, wherein the electrical wiring is arranged to define coils or windings.

13. The method of claim 12, wherein the coils or windings are arranged to form a stator for an electric motor.

14. The method of claim 12, wherein the coils or windings are arranged to permit inductive transfer of power or data.

15. The method of claim 1, wherein at least one of the tubing sections defines a linear motor.

16. The method of claim 1, wherein at least one of the tubing sections includes a heat-insulating material or arrangement.

17. The method of claim 16, wherein said heat-insulating material or arrangement is located between the first and second tubing sections.

18. The method of claim 1, wherein at least one of the tubing sections is electrically conducting and is electrically insulated to permit at least one of signals and power to be transmitted thereby.

19. The method of claim 1, wherein abutting surfaces of adjacent tubing sections define channels such that fluid conduits are defined between the tubing sections.

20. The method of claim 1, wherein the tubing sections are of different materials.

21. The method of claim 1, wherein the tubing sections have different structures.

22. The method of claim 1, wherein at least one of the tubing sections is of a corrosion-resistant material.

23. The method of claim 1, wherein at least one of the tubing sections is solid-walled.

24. The method of claim 1, wherein at least one of the tubing sections is slotted.

25. The method of claim 1, wherein at least one of the tubing sections is corrugated.

26. The method of claim 1, wherein the expanded tubing sections form a composite bore casing.

27. The method of claim 1, wherein the expanded tubing sections form a composite bore liner.

28. The method of claim 1, wherein at least one of the tubing sections is jointed.

29. The method of claim 1, wherein at least one of the tubing sections is reelable.

30. The method of claim 1, wherein a plurality of first tubing sections are located in the bore.

31. The method of claim 30, wherein said first tubing sections are arranged in end-to-end relationship.

32. The method of claim 31, wherein the second tubing section is located in the bore such that the ends of the second tubing section are spaced from the ends of the first tubing sections.

33. The method of claim 32, wherein seal arrangements are provided between the first and second tubing sections to provide a barrier to fluid flow between the tubing sections.

34. The method of claim 1, wherein at least one tubing section is of metal.

35. The method of claim 1, wherein at least one tubing section is non-metallic.

36. The method of claim 35, wherein said at least one tubing section is of a polymeric material.

37. The method of claim 1, wherein at least one tubing section is expandable without intervention.

38. The method of claim 37, wherein at least one tubing section expands in response to downhole temperatures.

39. A method of lining a bore section, the method comprising:
providing an expandable first tubing section, a corrugated expandable second tubing section and an expandable third tubing section;
running the first tubing section into a section of a bore and expanding the first tubing section to a larger diameter therein;
running the expandable second tubing section into said bore section, within the first tubing section, and expanding the second tubing section to a larger diameter; and
running the third tubing section into said bore section, within the first and second tubing sections, and expanding the third tubing section to a larger diameter.

40. A bore lining made in accordance with the method of claim 1.

41. A well bore which has been lined in accordance with the method of claim 1.

42. Apparatus for use in lining a bore, the apparatus comprising:
an expandable thin-walled first tubing section adapted for location in a bore section and expansion therein; and
an expandable thin-walled second tubing adapted for location in a bore within the first tubing section and expansion therein.
